(19) United States
(12) Patent Application Publication
(10) Pub. No.: US 2014/0169562 A1
(43) Pub. Date: Jun. 19, 2014

(54) METHOD AND SYSTEM FOR DYNAMICALLY ESTABLISHING ENCRYPTED TUNNELS ON CONSTRAINED-BAND NETWORKS

(71) Applicants: Dominique Billonneau, Gennevilliers (FR); Nicolas Suard, Gennevilliers (FR); Alain Sauzet, Gennevilliers (FR)

(72) Inventors: Dominique Billonneau, Gennevilliers (FR); Nicolas Suard, Gennevilliers (FR); Alain Sauzet, Gennevilliers (FR)

(73) Assignee: THALES, Neuilly-sur-Seine (FR)

(21) Appl. No.: 13/879,259

(22) PCT Filed: Oct. 10, 2011
(86) PCT No.: PCT/EP2011/067644

§ 371 Date: Aug. 20, 2013

(30) Foreign Application Priority Data
Oct. 12, 2010 (FR) 10 04015

(51) Int. Cl. H04L 29/06

(52) U.S. Cl. CPC H04L 63/0428
USPC 380/270

(57) ABSTRACT

A method and a system architecture making it possible to establish in a dynamic manner one or more encrypted tunnels on constrained-band communication networks is provided. It makes it possible in particular to encrypt one or more data streams while guaranteeing the quality of services on the constrained-band systems, in particular for encrypted streams of voice over IP type (Internet protocol) or of data type. These tunnels are thus adapted most suitably to the useful data streams while making it possible to control and assign the necessary values for the quality of service or QoS on these networks.

The subject of the invention relates to a method and a system architecture making it possible to establish in a dynamic manner one or more encrypted tunnels on constrained-band communication networks. It makes it possible notably to encrypt one or more data streams while guaranteeing the quality of services on constrained-band systems, in particular for encrypted streams of Voice over IP (Internet protocol) type or of data type. These tunnels are thus adapted exactly to the useful data streams while making it possible to monitor and to assign the values necessary for the quality of service or QoS on these networks.

The invention is, for example, used in systems implementing satcom satellite links of the following type: IP (Internet protocol) or Voice over IP in BGAN clear mode known to the person skilled in the art, or for modes known by the abbreviation “SwiftBroadband” and “FleetBroadband”. It also applies in respect of all communication systems referring to the part of the media-sharing standard known by the initials 3GPP.

### DEFINITIONS

Hereinafter in the discussion, the following abbreviations and their definitions will be used:

PDP: Packet Data Protocol, a PDP context stems from GPRS technology known to the person skilled in the art; it is a set of information which characterizes a base transmission service; it incorporates parameters which allow a subscriber to communicate with a well defined PDP address, according to a determined Quality of Service profile (lag, priority, bitrate, etc.).

RTP: Real Time Protocol. Protocol over IP which makes it possible to identify the type of the information item transported, to add markers and sequence numbers and to monitor the arrival of the packets at destination.

TFT: initials which designate a series of filters which ensure a determined path for applications whose stream is identified by the TFT filters, the abbreviation standing for “Traffic Flow Template”. For example, Inmarsat technology uses TFTs.

VoIP: Voice over IP.

SIP: service initialization protocol known as “Session Initiation Protocol.” This protocol is normalized and standardized. It also deals with negotiation on all the types of media usable by the various participants by encapsulating SDP (Session Description Protocol) messages. SIP does not transport the data exchanged during the session such as voice or video. SIP being independent of the transmission of the data, any type of data and of protocols can be used for this exchange. However, in actual practice, the RTP protocol usually ensures the audio and video sessions.

The word “streaming” designates a class of Satcom services guaranteeing a guaranteed bitrate (used mainly for real-time applications).

The word “transceiver” is used to designate a transmitter/receiver whose function is notably to broadcast an input signal to several outputs.

An outgoing call is defined as an Outbound call, an incoming call as an Inbound call.

Communications on the types of constrained-band networks and, mainly, on a satellite generally represent a high cost for the end consumer, and also for operators.

Increasingly, numerous applications are showing the need for encryption: for example for the maintenance information between an aircraft and its maintenance base, the private aspect of communications for VIPs, for military communications, etc. In all cases, the protection of the data often gives rise to a hike in communication costs.

Optimizing the costs of encrypting or securing data would enable access to the protection of the data to be made accessible to a larger number of people while making it possible to have prices accessible to end consumers; costs comparable or indeed identical to unprotected data.

The current encryption solutions known to the Applicant consist, for example, in opening an encrypted tunnel and in passing the traffic needing to be protected through this tunnel.

In the case of traffic requiring in addition to encryption a particular quality of service (phone stream, video, etc.) it is then necessary to use a guaranteed-band service class. In the Bgan, Fleetbroadband, Swiftbroadband systems or on all the systems referring to the part of the 3GPP standard, this consists in an opening of streaming. To pass the encrypted tunnel, the tunnel must be permanently open and the entirety of the traffic must pass through this tunnel. This is particularly unsuitable for telephony, especially in terms of cost since it is difficult to master the start and the end of a communication in order to open and close the tunnel.

The current trend known to the Applicant is to open a global tunnel in Best Effort, disregarding the quality of services, or to open a global tunnel associated with a 128-Kbyte stream or “streaming” for all the communications, hoping that several communications are established so as to cushion the cost of the streaming.

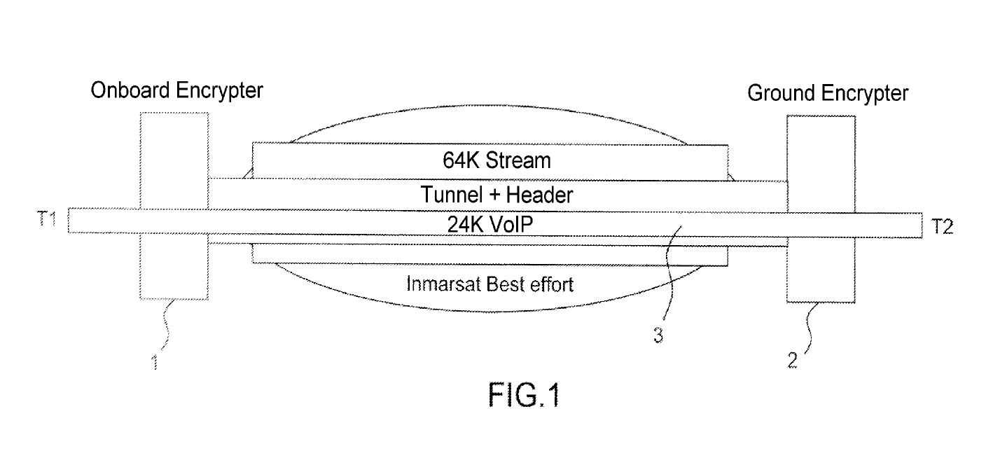

This trend is shown diagrammatically in FIG. 1 which represents a first terminal T₁, an Onboard encrypter 1 and a terminal T₂ with ground encrypter 2 with an example of communication artery encryption 3, wherein are represented the 64-Kbit stream, the 24K Voice over IP or VoIP, the tunnel+the encryption header, Best effort, in this example taken from the Inmarsat domain.

The invention relates to a system for establishing in a dynamic manner one or more encrypted tunnels for the transmission of data between a first terminal T₁ comprising an onboard encrypter and a receiver R₂ comprising a ground encrypter on constrained-band networks, said network using a real time protocol, characterized in that it comprises at least the following elements:

One or more terminals designated T₁, . . . , T₇ transmit, to an SIP server, the data streams to be conveyed to another recipient via a satellite S,

Said SIP server transmits said data stream to be encrypted to a router comprising a first encryption module and rules ensuring a path for an identified data stream,

The onboard encryption module will read the identifier of the port of the real time protocol present in the data frame to be encrypted, and if said identifier corresponds to a given value contained in a configuration file will encrypt the data stream with a key corresponding to the identified port,

Said encryption module adds an identification data field to the encrypted data frame,

A routing module will thereafter apply streaming channel assignment rules so as to transmit the encrypted data stream or streams to a modem comprising a module allowing the opening of a number of encrypted tunnels equal to the number of communications or per type of traffic,

The Satcom modem will thereafter transmit the various encrypted data streams via the various encrypted channels to the communication satellite S,

Said satellite S is linked up with a reception station which will distribute the encrypted data streams to a routing module (80), an encryption-decryption module,

Said encryption-decryption module comprises a lookup table (82) of correspondence between the value contained in the field identifying an encrypted data stream and an RTP port number and the correspondence between the decryption key to be used and the RTP value, decrypts the data streams and transmits the decrypted data to

A set of recipient terminals.

The data terminals are, for example, terminals of Voice over IP type.

The routing module applies the TFT rules, the communication system being a satellite system of BGAN, Swiftbroadband and Fleetbroadband or GPRS type.

A communication tunnel can be configured in a template file associating a traffic identified by an RTP, UDP port with an Espi value corresponding to an identifier of an encrypted tunnel, interpreted by TFT rules.

The encryption module implements, for example, an IPSec encryption.

The invention also relates to a method making it possible to establish in a dynamic manner encrypted tunnels or communications channels between at least two terminals, one being embedded on board a satellite, the other in a ground station within a communication system using a communication protocol, characterized in that it comprises at least the following steps:

At the Level of the Onboard Station

Opening of Several Tunnels
1) generating a configuration file which comprises for each end of a tunnel: the identification of the traffic or data stream to be encrypted, an encryption key, a port number or address of the destination,
2) encrypting a data stream by means of an encryption module, if said encryption module finds in said configuration file an identifier element corresponding to the identifier of the data stream to be encrypted, the data stream thus encrypted comprising a field identifying the destination address, the communication tunnel,
3) transmitting the encrypted traffic via a routing module and a modem, to a second routing module situated in the ground station
At the level of the ground station
5) decrypting the data stream by using the identifier of the tunnel and a lookup table of correspondence giving an encryption key associated with a tunnel,
6) transmitting the decrypted data stream to the recipient.

According to another variant embodiment, the invention relates to a method making it possible to establish in a dynamic manner encrypted tunnels or communications channels between at least two terminals, one being embedded on board a satellite, the other in a ground station within a communication system using a communication protocol, characterized in that it comprises at least the following steps:

At the Level of the Ground Station

Opening of Several Tunnels
1) generating a configuration file which comprises for each end of a tunnel: the identification of the traffic or data stream to be encrypted, an encryption key, a port number or address of the destination,
2) encrypting a data stream by means of an encryption module, if said encryption module finds in said configuration file an identifier element corresponding to the identifier of the data stream to be encrypted, the data stream thus encrypted comprising a field identifying the tunnel address,
3) transmitting the encrypted traffic via a routing module and a modem, to a second routing module situated in the Onboard station
At the level of the Onboard station
5) decrypting the data stream by using the identifier of the tunnel and a lookup table of correspondence giving an encryption key associated with a tunnel,
6) transmitting the decrypted data stream to the recipient.

Other characteristics and advantages of the device according to the invention will be more apparent on reading the description which follows of an exemplary embodiment given by way of wholly nonlimiting illustration together with the figures which represent:

FIG. 1, an exemplary encryption of a tunnel according to the prior art between an onboard terminal T₁ and a ground terminal T₂,

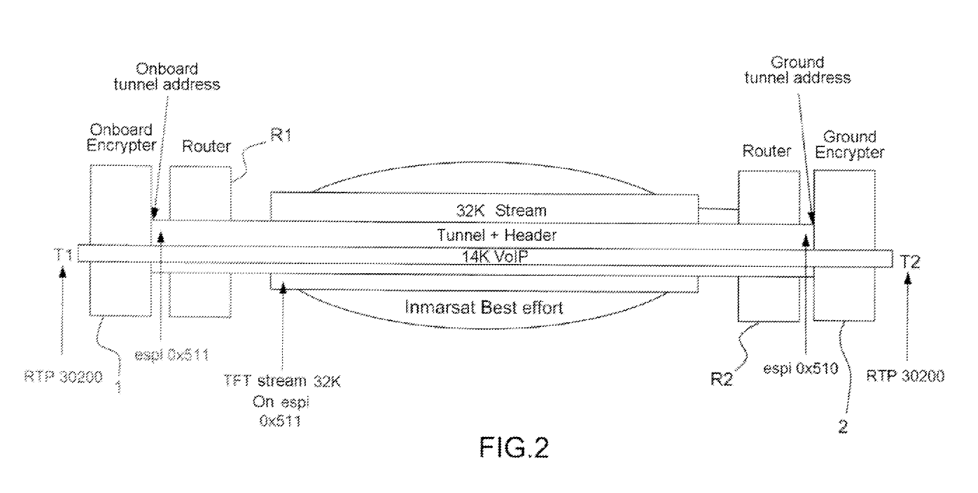

FIG. 2, an exemplary encryption architecture according to the invention,

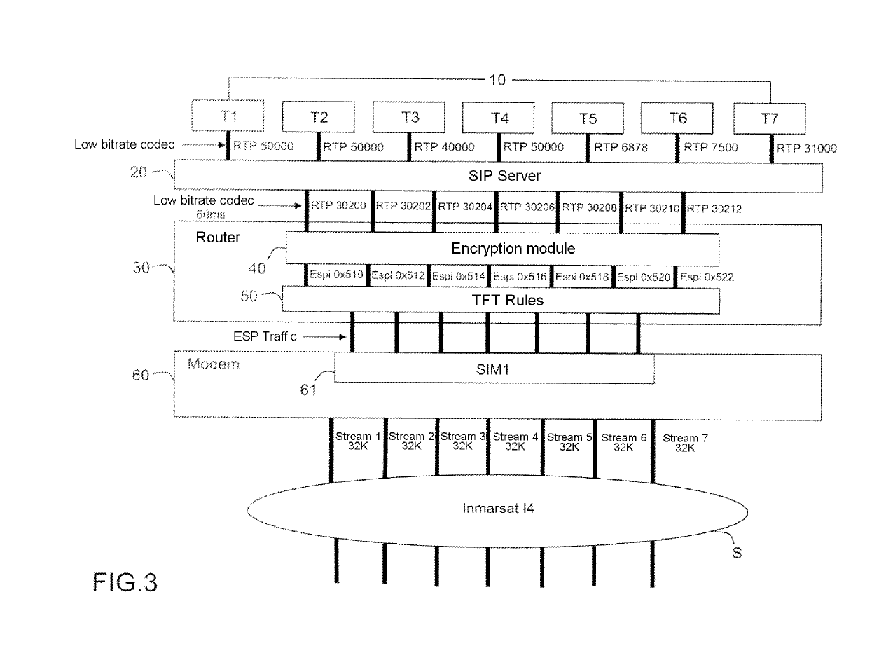

FIG. 3, an exemplary diagram in respect of modules of the air segment,

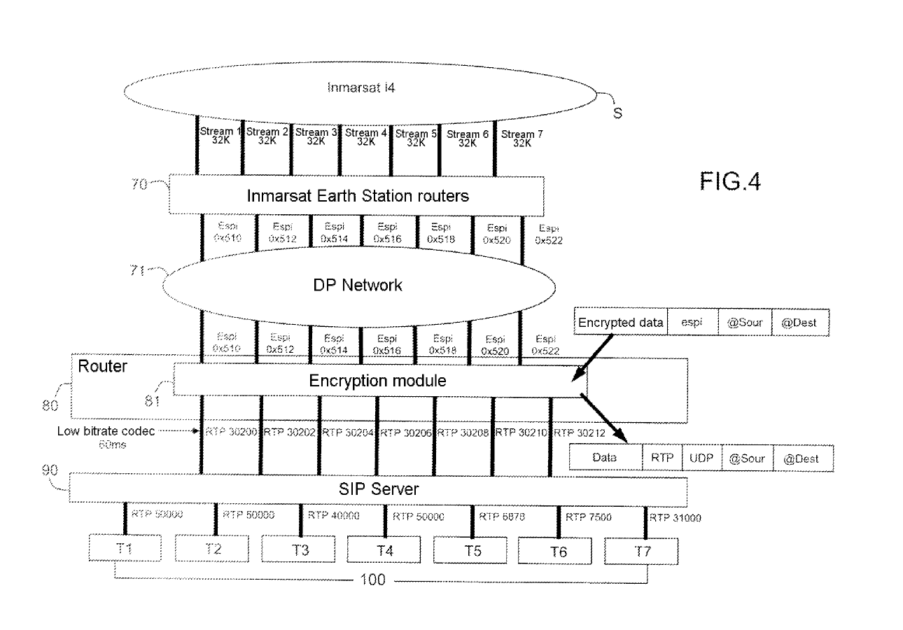

FIG. 4, an exemplary diagram in respect of modules of a ground segment, and

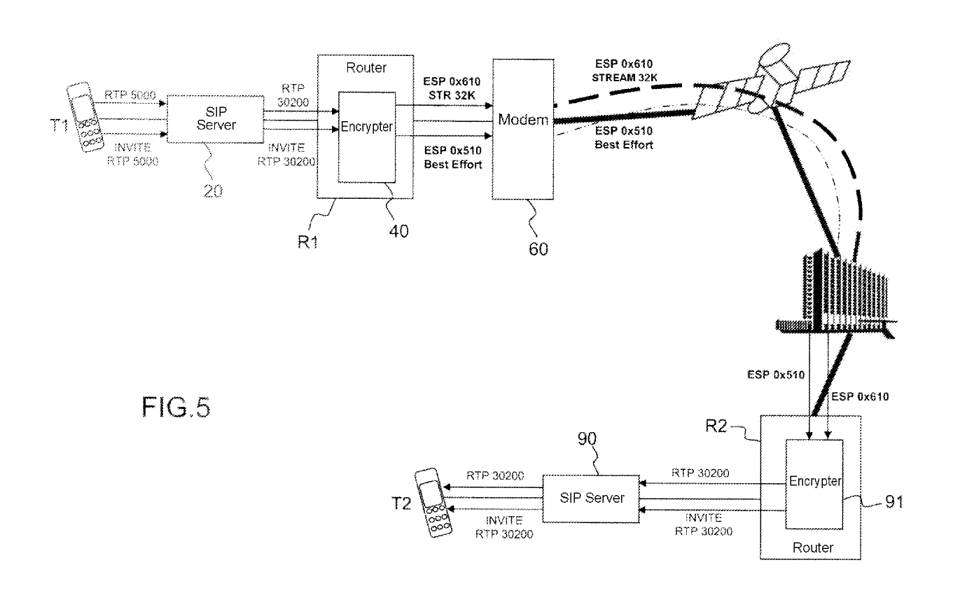

FIG. 5, the illustration of an End-to-End communication implementing the method according to the invention.

In order to better elucidate the invention, the description which follows by way of illustration is given for a system which uses the aforementioned SIP standard protocol. The mechanisms implemented are therefore transparent for any terminal compatible with the communication protocol used.

The method and the architecture according to the invention rely notably on IPSec encryption allowing the opening of an encrypted tunnel per communication and/or per type of traffic.

Each tunnel is configured, for example, in a template file which associates an identified traffic (e.g. RTP Port, UDP port, etc.) with a value “espi” hexadecimal identifier of an encrypted tunnel interpreted by the TFT rules ensuring a determined path with respect to an identified data stream.

The generation of the encryption keys is obtained with the aid of an IPSec configuration file which comprises for each tunnel end:

For the upgoing tunnel, the traffic identified, its associated identifier espi and the encryption key,

For the downgoing tunnel, the traffic identified, its associated identifier espi and the encryption key.

The data stream emanating from the first terminal T₁ is transmitted to an Onboard encrypter 1, in this exemplary implementation, and then passes through a router R₁, the function of which is notably to correctly direct the data stream to its recipient. The data stream frame generally comprises an identifier of the address of the sending source, an identifier for the final destination address for the communication.

A communication tunnel is configured in a file template which associates an identified traffic (e.g. RTP port, UDP port, etc.) with a value “espi” corresponding to an identifier of an encrypted tunnel, interpreted by the TFT rules. The data frame will comprise a tunnel identifier Idt.

The onboard encrypter will verify the identifier (RTP port, UDP port) of the data stream and encrypt the data of the stream if this identifier corresponds to a value (RTP, UDP port, etc.) which is contained in the IPSec configuration file.

The traffic or data stream F_{1C} thus encrypted contains an “espi” field which is set as a function of its identification; and then F_{1C} is assigned to a tunnel address by virtue of the router R₁.

In the case of telephony, the method according to the invention thus makes it possible to encrypt communication by communication streams of VoIP type, and to assign these streams the appropriate quality of service QoS, both on an Outband call and on an Inbound call.

For data, the method makes it possible to encrypt the streams service by service, and to assign these encrypted streams the appropriate quality of service QoS, both on an Outband call and on an Inbound call. This exhibits the advantage of appreciably reducing the bandwidth consumed and therefore the cost of the communications.

The method according to the invention also makes it possible to guarantee despite the significant overhead of the IPSec tunnel that all the VoIP communications will be encrypted and will benefit from a quality of service associated with a 32K stream or streaming, for example. Thus, this solution makes it possible to establish, for example and currently 7 simultaneous voice communications (RDP port) per terminal regardless of the type of vocoder used by this terminal.

After crossing the communication channel 3, the encrypted traffic F_{1C} is processed at the level of the receiver R₂ which will decrypt the data stream at the level of the ground encrypter 2 according to a method detailed in FIGS. 3 and 4.

FIG. 3 shows diagrammatically an exemplary architecture for the system operating in a terminal to the satellite direction.

In this figure, several terminals 10 designated T₁, . . . T₇ transmit, to an SIP server 20, the data streams to be conveyed to another recipient via the satellite.

The SIP server 20 is notably suitable for:

Intercepting the SIP signaling messages,

Modifying the RTP port numbers,

Intercepting and monitoring the RTP stream between the terminals,

Adapting the vocoder to the constraint of the encrypted bandwidth,

Dealing with monitoring the number of communications that can be established in the incoming or outgoing direction on the satellite segment,

Assigning the communications on the available “trunks”,

Monitoring and prohibiting the possibility of a call sent simultaneously by the aircraft or Onboard and the ground.

The SIP server will transmit the data streams to be encrypted to a router 30 comprising a first encryption module 40 and TFT rules.

The encryption module 40 will read the identifier of the RTP or UDP port present in the data frame to be encrypted, and then if a reference corresponds, it will encrypt the data stream with a key corresponding to the RTP or UDP port identified, using the correspondence array (IPSec configuration file). To these encrypted data, the encryption module 40 adds in the ESPI field the value which corresponds, in this example, to a hexadecimal value (IPsec identifier as a function of the RTP or UDP port number). This ESPI value is only visible from the Outside, the data of the stream are encrypted.

The encryption module has notably the following functions:

Assign an IPsec identifier as a function of the RTP or UDP port No. or other,

Establish an encrypted channel per VoIP communications or per type of transmission of data.

The router 30 will thereafter apply the streaming channel assignment TFT rules to transmit the encrypted data stream or streams to a modem 60 comprising for example 2 SIM cards 61, just one being represented in this figure. A SIM card will allow the opening of encrypted tunnel or communication channels. The Satcom modem will thereafter transmit the various encrypted data streams via the various streaming channels to the satellite S.

The function of the TFT rules manager is notably to apply streaming channel assignment TFT rules as a function of the ESPI field of the encrypted data frame or frames.

FIG. 4 shows diagrammatically the reverse direction of transmission of the data and openings of channels from the satellite to the recipients.

The satellite S having received the encrypted streams to be transmitted to recipients, transmits them to an earth station 70 for example. The network DP 71 represents the dealer partner offering the conveying contract for the earth station, Inmarsat satellite, Recipient.

The encrypted streams output by the distributor provider 71 are thereafter transmitted to a router 80 comprising an encryption module 81. The encryption module comprises notably a lookup table of correspondence between the value contained in the ESPI field of a data stream and an RTP port number. The decryption module will decrypt the data of the encrypted stream using the encryption key corresponding to the RTP or UDP port No.

The decrypted data stream will thereafter be transmitted to the SIP server which as a function of the RTP value will transmit the data stream to the final recipient.

FIG. 5 represents an exemplary distribution of the encrypted data streams from a terminal T₁ to a terminal T₂ via the satellite S and the encryption and routing systems described in FIGS. 3 and 4.

An exemplary implementation is given so as to better describe the simplified operation of the system according to the invention during an Outbound and Inbound call for encrypted VoIP streams.

Management of the Bandwidth

The IPSec overhead being very significant, it is absolutely necessary to have mastery over the type of coder negotiated and over the timing of the packets.

To be able to hold a VoIP communication in a 32K channel with encryption, the bandwidth of the VoIP (IP+UDP+RTP+Payload) must not exceed 16 Kbps.

This makes it necessary to use a low bitrate vocoder of good quality. In our example, the one chosen is the G729 whose timing is resequenced to 60 ms.

Outbound Call

When a call is sent by an Oubound VoIP terminal, the call message is dispatched to the terminal's management SIP server.

The SIP server responds to the calling terminal by a 100 Trying and then
modifies the RTP port announced by the calling terminal
verifies the vocoders
adapts the vocoding
retimes the packets

The message is thereafter transmitted to the encryption module.

Encryption Module

When a packet reaches it, the encryption module encrypts the packet and then fills in the ESP field with the value defined in the esp field of the tunnel configuration file. An exemplary encrypted application is given hereinafter.

E.g.: add “Onboard tunnel1 address”.“Ground tunnel1 address” esp 0x510

-m tunnel
-E rijndael-

cbc0x0838fe4d67ef6bd0745df33d684e4ed0137ca7e3e539a0827a5e185ac9b
1b6dc

-A hmac-sha256

0x3bd2851baf6d7e5f5197a8305ab81560bc78738b62f69a13b2a7754152b57b
24;
spdadd “Onboard SIP server address”[30200] “Ground SIP Server
address”[30200] any -P in ipsec

esp/tunnel/“Onboard tunnel1 address”-“Ground tunnel1

address”/require;

add ”.“Ground tunnel1 address” “Onboard tunnel1 address”[esp 0x511
-m tunnel
-E rijndael-cbc

0x44cec91db77812fc014efe4474918206817bad7466a322745c21e5ca978fc6
0d

-A hmac-sha256

0x46893ee4b29ab63709a8184be4f678fd14c8b392cf1881be716764020c631c
13;
spdadd “Ground SIP Server address”[30200] “Onboard SIP server Address”
any -P out ipsec

esp/tunnel/“Ground tunnel1 address”-“Onboard tunnel1

address”/require;

On receipt of a packet whose ESP field corresponds to a rule (in the example 0x510 Outbound and 0x511 Inbound), the traffic is immediately assigned to a streaming channel if the resource is available.

Inbound Call

The upgoing signaling is performed in Best effort.

The Onboard router receives the ESP packets and transmits them to the encrypter. The packet thus decrypted is thereafter dispatched to the SIP server for transmission to the recipient terminal.

When the onboard terminal is taken off-hook, the RTP traffic is established and then dispatched to the encrypter.

As a function of the configuration of the file, an espi field is assigned to the traffic after encryption and then dispatched to the router for assignment of a TFT rule.

An identified stream 0x510 and an identified stream 0x511 travels in best effort. These streams have a correspondence in the management of the TFTs which automatically assigns a channel STREAM32K to this type of stream.

The communication is automatically set to the type of streaming stream.

The method and the system architecture according to the invention exhibit notably the following advantages:

For an incoming or outgoing stream, the solution makes it possible:

to implement the appropriate resource in terms of QoS and bitrate consumption,

to enable the stream to benefit from a guaranteed bandwidth on the constrained segment,

to allow selection of the streams to be encrypted, some possibly thus remaining as clear plaintext.

The solution being based on IPSec encryption allows the opening of an encrypted tunnel per communication and/or per type of traffic.

For telephony, the solution makes it possible to encrypt communication by communication streams of VoIP type, and to assign these streams the appropriate quality of service, both on an Outband call, and on an Inbound call.

For data, the implementation of the present invention makes it possible to encrypt the streams services by services, and to assign these streams the appropriate quality of service QoS, both on an Outband call and on an Inbound call. This makes it possible to appreciably reduce the bandwidth consumed and therefore the cost of the communications.

The subject of the present invention guarantees despite the significant overhead of the IPsec tunnel that all the VoIP communications will be encrypted and will benefit from a quality of service associated with 32K streaming.

1. A system for establishing in a dynamic manner one or more encrypted tunnels for the transmission of data between a first terminal T1 comprising an onboard encrypter and a receiver R2 comprising a ground encrypter on constrained-band networks, said network using a real-time communication protocol, comprising at least the following elements:
one or more terminals designated T₁, . . . T₇ transmit, to an SIP server, the data streams to be conveyed to another recipient via a satellite S,
said SIP server transmits said data stream to be encrypted to a router comprising a first encryption module and rules ensuring a path for an identified data stream,
the onboard encryption module will read the identifier of the port of the real time protocol present in the data frame to be encrypted, and if said identifier corresponds to a given value contained in a configuration file, will encrypt the data stream with a key corresponding to the identified port,
said encryption module adds an identification data field to the encrypted data frame,
a routing module will thereafter apply streaming channel assignment rules so as to transmit the encrypted data stream or streams to a modem comprising a module allowing the opening of a number of encrypted tunnels equal to the number of communications or per type of traffic,
the Satcom modem will thereafter transmit the various encrypted data streams via the various encrypted channels to the communication satellite S,
said satellite S is linked up with a reception station which will distribute the encrypted data streams to a routing module, an encryption-decryption module
said encryption-decryption module comprises a lookup table of correspondence between the value contained in the field identifying an encrypted data stream and an RTP port number and the correspondence between the decryption key to be used and the RTP value, decrypts the data streams and transmits the decrypted data to a set of recipient terminals.

2. The system as claimed in claim 1 wherein the data terminals are terminals of Voice over IP type.

3. The system as claimed in claim 1 wherein the routing module applies the TFT rules, the communication system being a satellite system of BGAN, Swiftbroadband and Fleetbroadband or GPRS type.

4. The system as claimed in claim 1, wherein a communication tunnel is configured in a template file associating a traffic identified by an RTP, UDP port with an Espi value corresponding to an identifier of an encrypted tunnel, interpreted by TFT rules.

5. The system as claimed in claim 1, wherein the encryption module implements an IPSec encryption.

6. A method making it possible to establish in a dynamic manner encrypted tunnels or communications channels between at least two terminals, one being embedded on board a satellite, the other in a ground station within a communication system as claimed in claim 1 using a communication protocol, comprising at least the following steps:
at the level of the onboard station
opening of several tunnels
generating a configuration file which comprises for each end of a tunnel: the identification of the traffic or data stream to be encrypted, an encryption key, a port number or address of the destination,
encrypting a data stream by means of an encryption module, if said encryption module finds in said configuration file an identifier element corresponding to the identifier of the data stream to be encrypted, the data stream thus encrypted comprising a field identifying the destination address, the communication tunnel,
transmitting the encrypted traffic via a routing module and a modem, to a second routing module situated in the ground station
at the level of the ground station
decrypting the data stream by using the identifier of the tunnel and a lookup table of correspondence giving an encryption key associated with a tunnel,
transmitting the decrypted data stream to the recipient.

7. A method making it possible to establish in a dynamic manner encrypted tunnels or communications channels between at least two terminals, one being embedded on board a satellite, the other in a ground station within a communication system as claimed in claim 1 using a communication protocol, comprising at least the following steps:
at the level of the ground station
opening of several tunnels
generating a configuration file which comprises for each end of a tunnel: the identification of the traffic or data stream to be encrypted, an encryption key, a port number or address of the destination,
encrypting a data stream by means of an encryption module, if said encryption module finds in said configuration file an identifier element corresponding to the identifier of the data stream to be encrypted, the data stream thus encrypted comprising a field identifying the tunnel address,
transmitting the encrypted traffic via a routing module and a modem, to a second routing module situated in the onboard station at the level of the onboard station
decrypting the data stream by using the identifier of the tunnel and a lookup table of correspondence giving an encryption key associated with a tunnel,
transmitting the decrypted data stream to the recipient.

8. The use of the system as claimed in claim 1 for the SIP standard protocol.

9. The use of the system as claimed in claim 6 for the SIP standard protocol.
